(19) United States
(12) Patent Application Publication
(10) Pub. No.: US 2016/0247180 A1
(43) Pub. Date: Aug. 25, 2016

(54) VERIFYING EXPOSURE OF USER TO ADVERTISING

(71) Applicant: International Business Machines Corporation, Armonk, NY (US)

(72) Inventors: Kulvir S. Bhogal, Fort Worth, TX (US); Gregory J. Boss, Saginaw, MI (US); Jill S. Dhillon, Houston, TX (US); Rick A. Hamilton, II, Charlottesville, VA (US)

(21) Appl. No.: 14/629,799

(22) Filed: Feb. 24, 2015

(51) Int. Cl. G06Q 30/02

(52) U.S. Cl. CPC G06Q 30/0214; G06Q 30/0242

(57) ABSTRACT

Approaches for verifying a user's exposure to a commercial event are included. Various embodiments include a system having: at least one computing device configured to verify exposure of a user to a commercial event by performing actions including: prompting the user to provide an indication of exposure to the commercial event; obtaining the indication of exposure to the commercial event from the user; authenticating the indication of exposure obtained from the user; and crediting the user for exposure to the commercial event in response to the authenticating.

### TECHNICAL FIELD

Aspects of the invention relate generally to advertising. More particularly, various aspects of the invention relate to approaches for verifying exposure of users to advertising.

### BACKGROUND

Advertisements have long been a staple in every day human life. From billboards proximate roadways, to commercials within television programming, to banner advertisements on web pages, an average person is exposed to dozens of advertisements during a given day. Understanding the effectiveness of these advertisements, and harnessing the power of effective advertisements, is of particular importance to marketing and advertising companies, as well as to purveyors of goods and providers of services. However, despite technological advancements in the delivery and analysis of advertisements, it is still difficult to determine the level of exposure a person receives to a given advertisement.

### BRIEF SUMMARY

Approaches for verifying a user's exposure to a commercial event are included. Various embodiments include a system having: at least one computing device configured to verify exposure of a user to a commercial event by performing actions including:

prompting the user to provide an indication of exposure to the commercial event;
obtaining the indication of exposure to the commercial event from the user;
authenticating the indication of exposure obtained from the user; and crediting the user for exposure to the commercial event in response to the authenticating.

A first aspect includes a system having: at least one computing device configured to verify exposure of a user to a commercial event by performing actions including: prompting the user to provide an indication of exposure to the commercial event; obtaining the indication of exposure to the commercial event from the user; authenticating the indication of exposure obtained from the user; and crediting the user for exposure to the commercial event in response to the authenticating.

A second aspect includes a computer program product having program code stored on a computer readable storage medium, which when executed by at least one computing device, causes the at least one computing device to verify exposure of a user to a commercial event by performing actions including: prompting the user to provide an indication of exposure to the commercial event; obtaining the indication of exposure to the commercial event from the user; authenticating the indication of exposure obtained from the user; and crediting the user for exposure to the commercial event in response to the authenticating.

A third aspect includes a system having: at least one computing device configured to verify exposure of a user to a commercial event by performing actions including: prompting the user to provide an indication of exposure to the commercial event, wherein the commercial event occurs during one of a live event or a time-delayed event, wherein, in the case that the commercial event includes an advertisement presented during the time-delayed event, the prompting of the user includes at least one of prompting the user to capture an image of the commercial event or an audio segment of the commercial event; obtaining the indication of exposure to the commercial event from the user; authenticating the indication of exposure obtained from the user, wherein, in the case that the commercial event includes an advertisement presented during the live event, the authenticating includes verifying a time-stamp of the indication of exposure corresponds with a time of the live event, and wherein, in the case that the commercial event includes an advertisement presented during the time-delayed event, the authenticating includes verifying that the image of the commercial event or the audio segment of the commercial event corresponds with content presented in the time-delayed event; and crediting the user for exposure to the commercial event in response to the authenticating.

### BRIEF DESCRIPTION OF THE DRAWINGS

FIG. 1 illustrates an environment including a commercial event exposure verification program, according to various embodiments of the disclosure.

FIG. 2 shows a flow diagram illustrating processes according to various embodiments of the disclosure.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

As noted herein, various aspects of the disclosure relate generally to advertising. More particularly, various aspects of the invention relate to approaches for verifying exposure of users to advertising.

Commonly labeled components in the FIGURES are considered to be substantially equivalent components for the purposes of illustration, and redundant discussion of those components is omitted for clarity.

Various embodiments include systems, computer program products, and methods for verifying a user's exposure to a commercial event (e.g., an advertisement). As used herein, the term “commercial event” can refer to any form of advertisement, product placement, or exposure to a coordinated branding/commercial campaign. Examples of commercial events can include: television and/or programming commercials, webpage advertisements (e.g., embedded, clickable advertisements), billboards or other signage including advertisements, product placement within a program or other content (e.g., display of a particular good in the home of a television character's home), etc. In various particular embodiments, a commercial event can include an advertisement placed in either a live event (e.g., a live television broadcast) or an advertisement placed in a time-delayed event (e.g., a recorded broadcast, a streaming video or audio program, etc.).

As discussed herein various approaches include verifying a user's exposure to a commercial event, and in some cases, can include tracking a user's exposure to one or more commercial events in order to determine a suitable subsequent commercial event (e.g., advertisement) for which to expose the user. In some cases, aspects include creating a profile for the user, and based upon verified exposure to commercial events, tailoring subsequent commercial events to the particular user's profile. In various cases, the user can accumulate credits for verifying exposure to one or more commercial events, and can redeem those credits for rewards, such as, e.g., a pass to view entertainment content without commercial interruption, a pass to view entertainment content without additional cost, a redeemable discount for viewing entertainment content, or a redeemable discount for purchasing goods or services associated with a subject of the commercial event.

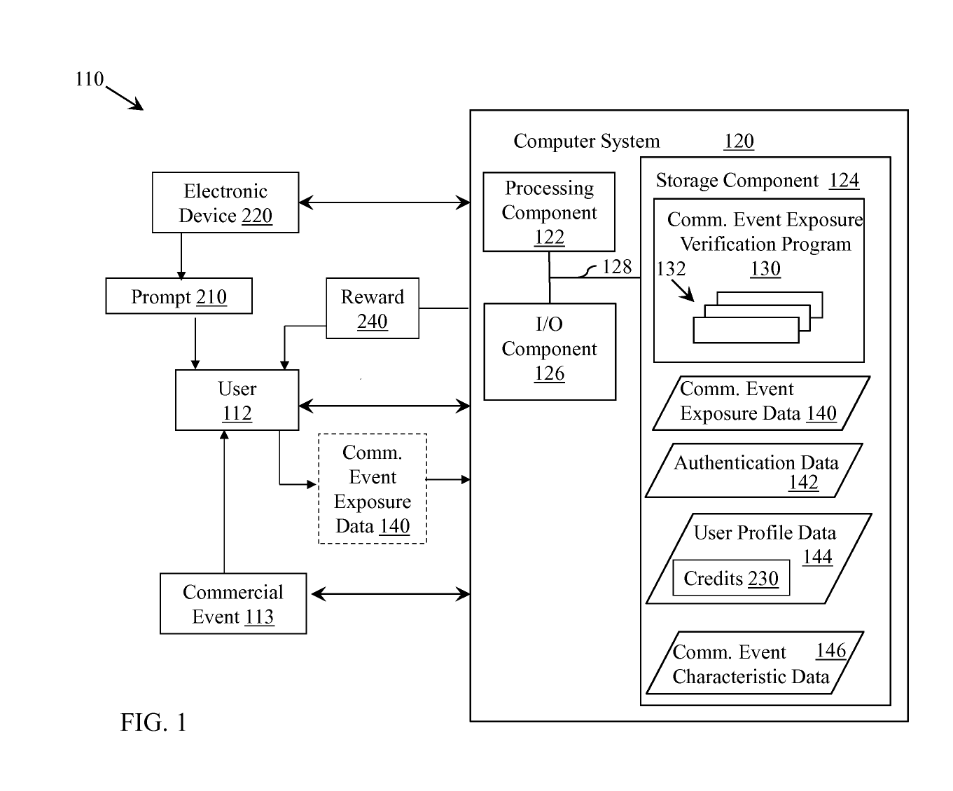

FIG. 1 shows an illustrative environment 110 for verifying exposure of a user 112 to a commercial event (commercial event 113) according to an embodiment of the invention. To this extent, environment 110 includes a computer system 120 that can perform a process described herein in order to verifying exposure of user 112 to commercial event (commercial event 113). In particular, computer system 120 is shown including a commercial event exposure verification program 130, which makes computer system 120 operable to verify exposure of user 112 to commercial event 113 by performing processes described herein.

Computer system 120 is shown including a processing component 122 (e.g., one or more processors), a storage component 124 (e.g., a storage hierarchy), an input/output (I/O) component 126 (e.g., one or more I/O interfaces and/or devices), and a communications pathway 128. In general, processing component 122 executes program code, such as commercial event exposure verification program 130, which is at least partially fixed in storage component 124. While executing program code, processing component 122 can process data, which can result in reading and/or writing transformed data from/to storage component 124 and/or I/O component 126 for further processing. Pathway 128 provides a communications link between each of the components in computer system 120. I/O component 126 can comprise one or more human I/O devices, which enable a human user 112 to interact with computer system 120 and/or one or more communications devices to enable a system user 112 to communicate with computer system 120 using any type of communications link. To this extent, commercial event exposure verification program 130 can manage a set of interfaces (e.g., graphical user interface(s), application program interface, and/or the like that enable human and/or system users 112 to interact with commercial event exposure verification program 130. Further, commercial event exposure verification program 130 can manage (e.g., store, retrieve, create, manipulate, organize, present, etc.) data, such as indication of commercial event exposure data 140 (e.g., data from user 112 indicating exposure to commercial event 113, which may include a time-stamp, a captured image of the commercial event 113, a captured audio segment of the commercial event 113, etc.), authentication data 142 (e.g., data indicating a time of broadcast or re-broadcast of commercial event 113, audio verification data for comparison with a captured audio segment, image verification data for comparison with a captured image, etc.), user profile data 144 (e.g., profile data including information about the user 112, e.g., demographic information, data indicating responses to commercial event(s) 113, account credits, rewards, etc. associated with verified exposure to commercial event(s) 113) and/or commercial event characteristic data 146 (e.g., data categorizing commercial events 113, which can be cross-referenced with user profile data 144, to determine which subsequent commercial event(s) 113 are likely to be most effective in drawing/retaining the attention of user 112, and are most likely to engage the user 112 such that user will verify exposure to that subsequent commercial event 113).

In any event, computer system 120 (including commercial event exposure verification program 130) can obtain commercial event exposure data 140, authentication data 142, user profile data 144 and/or commercial event characteristic data 146 using any solution. Computer system 120 can comprise one or more general purpose computing articles of manufacture (e.g., computing devices) capable of executing program code, such as commercial event exposure verification program 130, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, commercial event exposure verification program 130 can be embodied as any combination of system software and/or application software.

Further, commercial event exposure verification program 130 can be implemented using a set of modules 132. In this case, a module 132 can enable computer system 120 to perform a set of tasks used by commercial event exposure verification program 130, and can be separately developed and/or implemented apart from other portions of commercial event exposure verification program 130. As used herein, the term “component” means any configuration of hardware, with or without software, which implements the functionality described in conjunction therewith using any solution, while the term “module” means program code that enables a computer system 120 to implement the actions described in conjunction therewith using any solution. When fixed in a storage component 124 of a computer system 120 that includes a processing component 122, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 120.

When computer system 120 comprises multiple computing devices, each computing device can have only a portion of commercial event exposure verification program 130 fixed thereon (e.g., one or more modules 132). However, it is understood that computer system 120 and commercial event exposure verification program 130 are only representative of various possible equivalent computer systems that may perform a process described herein. To this extent, in other embodiments, the functionality provided by computer system 120 and commercial event exposure verification program 130 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 120 includes multiple computing devices, the computing devices can communicate over any type of communications link. Further, while performing a process described herein, computer system 120 can communicate with one or more other computer systems using any type of communications link. In either case, the communications link can comprise any combination of various types of optical fiber, wired, and/or wireless links; comprise any combination of one or more types of networks; and/or utilize any combination of various types of transmission techniques and protocols.

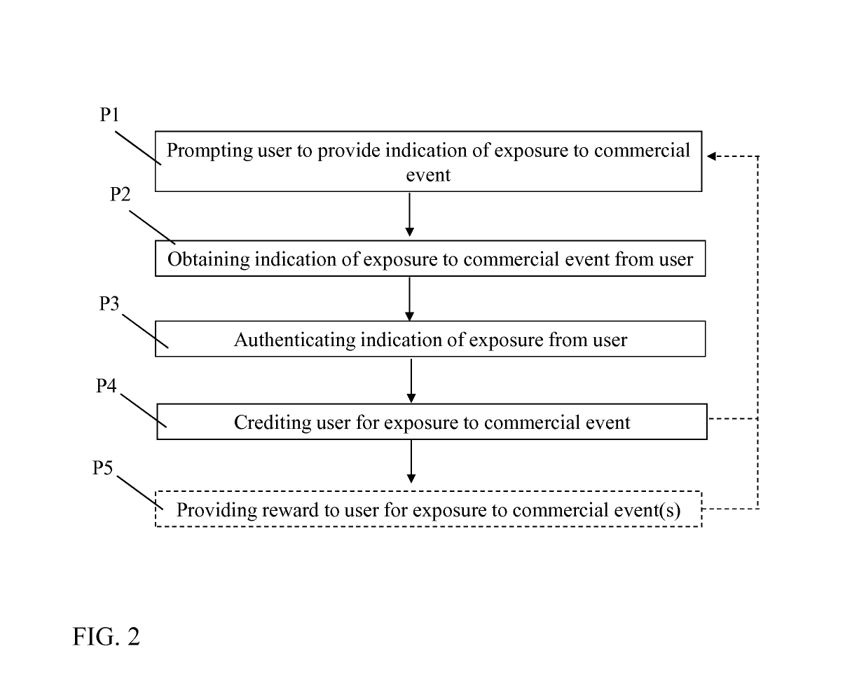

According to various embodiments, aspects include systems, computer program products and methods for verifying exposure of a user to a commercial event. FIG. 2 shows a flow diagram illustrating an approach according to various embodiments, with processes illustrated as:

Process P1: prompting the user 112 to provide an indication of exposure to the commercial event 113. In various embodiments, this may include providing a prompt 210 to user 112 at an electronic device 220 (such as a mobile phone, PDA, smartphone, tablet, laptop computer, personal computer, wearable computing device (e.g., computing glasses, watches, belts, bands, clips, etc.). This prompt 210 can be presented to user 112 in the form of an application (e.g., a mobile application), or via other conventional communications protocols. The prompt 210 can be integrated with one or more services providing content to the user, e.g., a video streaming service, an application associated with a live broadcast, an application associated with a physical advertisement such as a billboard which uses proximity to trigger the prompt 210, etc. The prompt 210 may request that the user 112 provide data indicating his/her exposure to the commercial event 113. In some cases, where the commercial event 113 is an advertisement presented during a time-delayed event (e.g., during a recorded event, streaming event, or presented over an extended period, such as a billboard advertisement or other stationary advertisement), the prompt 210 may request that user 112 capture an image (e.g., with a phone integrated with an electronic device) or an audio segment (e.g., with a recorder integrated with an electronic device) of the event/content, and provide the specific indication of exposure (commercial event exposure data 140) to the computer system 120. In various other embodiments, the prompt 210 may request that the user 112 complete a quiz and/or verification test to verify exposure to the commercial event 113. The quiz/verification test may be utilized in verifying exposure to live and/or time-delayed events.

In various embodiments, following process P1, process P2 includes: obtaining the indication of exposure (commercial event exposure data 140) to the commercial event 113 from the user 112. In some cases, this can include obtaining the commercial event exposure data 140 via a mobile application, website, or direct-communication protocol. In various embodiments the commercial event exposure data 140 can include a time-stamp indicating an approximate time at which the user 112 responded to the prompt 210.

Following process P2, in various embodiments, process P3 includes: authenticating the indication of exposure (commercial event exposure data 140) obtained from the user 112. In various embodiments, authentication can include comparing the commercial event exposure data 140 with authentication data 142 (e.g., data indicating a time of broadcast or re-broadcast of commercial event 113, audio verification data for comparison with a captured audio segment, image verification data for comparison with a captured image, etc.). That is, in the case that the commercial event 113 includes an advertisement presented during a live event, the authenticating includes verifying that the time-stamp of the indication of exposure (commercial event exposure data 140) corresponds with a time of the live event. In the case that the commercial event 113 includes an advertisement presented during a time-delayed event (e.g., during a recorded event, streaming event, or presented over an extended period, such as a billboard advertisement or other stationary advertisement), the authenticating includes verifying that the image (in commercial event exposure data 140) of the commercial event 113 or the audio segment (in commercial event exposure data 140) of the commercial event 113 corresponds with content presented in the time-delayed event.

In various embodiments, in response to authenticating the commercial event exposure data 140, process P4 can include: crediting the user 112 for exposure to the commercial event 113. In various embodiments, when exposure to the commercial event 113 is authenticated, user profile data 144 is updated to include data indicating exposure to the commercial event 113. The user 112 may accumulate one or more commercial event credits 230 indicating exposure to commercial events 113.

In some cases, which may be optional in some embodiments, process P5 can include providing a reward 240 to the user 112 for exposure to one or more commercial event(s) 113. In some cases, when user profile data 144 indicates that the user 112 has met a threshold level of exposure to commercial event(s) 113 (e.g., accumulated a threshold number of credits 230), a reward 240 can be allocated, for example, as an actuatable reward 240 stored in user profile data 144 which the user 112 can redeem for one or more benefits. In various embodiments, reward 240 can include a pass to view entertainment content without commercial interruption, a pass to view entertainment content without additional cost, a redeemable discount for viewing entertainment content, or a redeemable discount for purchasing goods or services associated with a subject of the commercial event 113 (e.g., from the soda company that placed the advertisement to which the user 112 was exposed, as verified).

According to various embodiments, processes P1-P4 (and in some cases, P1-P5) can be repeated for subsequent commercial events 113, e.g., such as a succession of commercial events 113 within a single event (e.g., live broadcast, streaming program, etc.).

It is understood that in various additional embodiments, user 112 can link between commercial event exposure verification program 130 and other conventional programs, e.g., social networks, blogs, etc., in order to notify other users about commercial event exposure verification program 130. That is, in various embodiments, user 112 could “post” or otherwise notify others of rewards 240 obtained via commercial event exposure verification program 130. Commercial event exposure verification program 130 can link with these other programs (e.g., social networks) to allow user 112 to easily provide this information to his/her network.

According to various embodiments, user 112 can be prompted to provide a series of indications of commercial exposure (commercial event exposure data 140) to a series of commercial events 113 (e.g., advertisements) during an event (e.g., live event, streaming event, etc.), where subsequent commercial events 113 are chosen based upon the exposure in at least one verified previous commercial event 113. For example, commercial event characteristic data 146 can include data categorizing commercial events 113, which can be cross-referenced with user profile data 144, to determine which subsequent commercial event(s) 113 are likely to be most effective in drawing/retaining the attention of user 112, and are most likely to engage the user 112 such that user will verify exposure to that subsequent commercial event 113. In these cases, subsequent commercial events 113 can be tailored to the user 112, such that those commercial events 113 may be more attractive to user 112, and in some cases, may be more effective at obtaining/retaining the loyalty of user 112 with respect to the product or service.

Various embodiments of the disclosure include approaches for verifying exposure of a user 112 to a commercial event 113. It is understood that the technical effect of the various embodiments described herein is to verify exposure of user 112 to one or more commercial events 113, and tailor subsequent commercial events 113 to enhance the effectiveness of those commercial events 113 with respect to user 112. As discussed herein, the commercial event exposure verification program 130 enables computer system 120 to verify exposure of user 112 to commercial event 113 according to the various embodiments of the disclosure.

While shown and described herein as a method and system for verifying exposure of a user to a commercial event, it is understood that aspects of the invention further provide various alternative embodiments. For example, in one embodiment, the invention provides a computer program fixed in at least one computer-readable medium, which when executed, enables a computer system to verify exposure of a user to commercial event. To this extent, the computer-readable medium includes program code, such as commercial event exposure verification program 130 (FIG. 1), which enables a computer system to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as commercial event exposure verification program 130 (FIG. 1), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a commercial event exposure verification program 130. In this case, a computer system, such as computer system 120 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

It is understood that aspects of the invention can be implemented as part of a business method that performs a process described herein on a subscription, advertising, and/or fee basis. That is, a service provider could offer to verify commercial event exposure as described herein. In this case, the service provider can manage (e.g., create, maintain, support, etc.) a computer system, such as computer system 120 (FIG. 1), that performs a process described herein for one or more customers. In return, the service provider can receive payment from the customer(s) under a subscription and/or fee agreement, receive payment from the sale of advertising to one or more third parties, and/or the like.

In various embodiments, components described as being “coupled” to one another can be joined along one or more interfaces. In some embodiments, these interfaces can include junctions between distinct components, and in other cases, these interfaces can include a solidly and/or integrally formed interconnection. That is, in some cases, components that are “coupled” to one another can be simultaneously formed to define a single continuous member. However, in other embodiments, these coupled components can be formed as separate members and be subsequently joined through known processes (e.g., soldering, fastening, ultrasonic welding, bonding). In various embodiments, electronic components described as being “coupled” can be linked via conventional hard-wired and/or wireless means such that these electronic components can communicate data with one another.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A system comprising:
at least one computing device configured to verify exposure of a user to a commercial event by performing actions including:
prompting the user to provide an indication of exposure to the commercial event;
obtaining the indication of exposure to the commercial event from the user;
authenticating the indication of exposure obtained from the user; and
crediting the user for exposure to the commercial event in response to the authenticating.

2. The system of claim 1, wherein the at least one computing device is further configured to provide a reward to the user for exposure to the commercial event.

3. The system of claim 2, wherein the reward includes a pass to view entertainment content without commercial interruption, or a pass to view entertainment content without additional cost.

4. The system of claim 2, wherein the reward includes a redeemable discount for viewing entertainment content, or a redeemable discount for purchasing goods or services associated with a subject of the commercial event.

5. The system of claim 1, wherein the crediting includes adding a credit to a commercial event credit account associated with the user.

6. The system of claim 5, wherein, in response to the commercial event credit account accumulating a threshold number of credits, the at least one computing device is further configured to provide a reward to the user.

7. The system of claim 1, wherein the commercial event includes at least one of an advertisement presented during a live event or an advertisement presented during a time-delayed event.

8. The system of claim 1, wherein, in the case that the commercial event includes an advertisement presented during a live event, the authenticating include verifying a time-stamp of the indication of exposure corresponds with a time of the live event.

9. The system of claim 1, wherein, in the case that the commercial event includes an advertisement presented during a time-delayed event, the prompting of the user includes at least one of prompting the user to capture an image of the commercial event or an audio segment of the commercial event, and the authenticating includes verifying that the image of the commercial event or the audio segment of the commercial event corresponds with content presented in the time-delayed event.

10. The system of claim 1, wherein the at least one computing device is further configured to prompt the user to provide a series of indications of commercial exposure to a series of commercial events during an event, and wherein subsequent commercial events are chosen based upon the exposure in at least one verified previous commercial event.

11. A computer program product comprising program code stored on a computer readable storage medium, which when executed by at least one computing device, causes the at least one computing device to verify exposure of a user to a commercial event by performing actions including:
prompting the user to provide an indication of exposure to the commercial event;
obtaining the indication of exposure to the commercial event from the user;
authenticating the indication of exposure obtained from the user; and
crediting the user for exposure to the commercial event in response to the authenticating.

12. The computer program product of claim 11, which when executed by the at least one computing device, causes the at least one computing device to further provide a reward to the user for exposure to the commercial event, wherein the reward includes at least one of: a pass to view entertainment content without commercial interruption, a pass to view entertainment content without additional cost, a redeemable discount for viewing entertainment content, or a redeemable discount for purchasing goods or services associated with a subject of the commercial event.

13. The computer program product of claim 11, wherein the crediting includes adding a credit to a commercial event credit account associated with the user. wherein, in response to the commercial event credit account accumulating a threshold number of credits, the at least one computing device is further configured to provide a reward to the user.

14. The computer program product of claim 11, wherein, in the case that the commercial event includes an advertisement presented during a live event, the authenticating include verifying a time-stamp of the indication of exposure corresponds with a time of the live event.

15. The computer program product of claim 11, wherein, in the case that the commercial event includes an advertisement presented during a time-delayed event, the prompting of the user includes at least one of prompting the user to capture an image of the commercial event or an audio segment of the commercial event, and the authenticating includes verifying that the image of the commercial event or the audio segment of the commercial event corresponds with content presented in the time-delayed event.

16. The computer program product of claim 11, which when executed by the at least one computing device, causes the at least one computing device to further prompt the user to provide a series of indications of commercial exposure to a series of commercial events during an event, and wherein subsequent commercial events are chosen based upon the exposure in at least one verified previous commercial event.

17. A system comprising:
at least one computing device configured to verify exposure of a user to a commercial event by performing actions including:
prompting the user to provide an indication of exposure to the commercial event,
wherein the commercial event occurs during one of a live event or a time-delayed event, wherein, in the case that the commercial event includes an advertisement presented during the time-delayed event, the prompting of the user includes at least one of prompting the user to capture an image of the commercial event or an audio segment of the commercial event;
obtaining the indication of exposure to the commercial event from the user;
authenticating the indication of exposure obtained from the user,
wherein, in the case that the commercial event includes an advertisement presented during the live event, the authenticating include verifying a time-stamp of the indication of exposure corresponds with a time of the live event, and wherein, in the case that the commercial event includes an advertisement presented during the time-delayed event, the authenticating includes verifying that the image of the commercial event or the audio segment of the commercial event corresponds with content presented in the time-delayed event; and
crediting the user for exposure to the commercial event in response to the authenticating.

18. The system of claim 17, wherein the at least one computing device is further configured to provide a reward to the user for exposure to the commercial event, wherein the reward includes at least one of: a pass to view entertainment content without commercial interruption, a pass to view entertainment content without additional cost, a redeemable discount for viewing entertainment content, or a redeemable discount for purchasing goods or services associated with a subject of the commercial event.

19. The system of claim 17, wherein the crediting includes adding a credit to a commercial event credit account associated with the user.

20. The system of claim 19, wherein, in response to the commercial event credit account accumulating a threshold number of credits, the at least one computing device is further configured to provide a reward to the user.
